(19) United States
(12) Patent Application Publication
(10) Pub. No.: US 2008/0305298 A1
(43) Pub. Date: Dec. 11, 2008

(54) LASER ACTIVATION OF ELASTIC LAMINATES

(75) Inventors: Brinda B. Lakshmi, Woodbury, MN (US); Charles J. Studiner, IV, Cottage Grove, MN (US); Pingfan Wu, Woodbury, MN (US); Robert L.W. Smithson, Mahtomedi, MN (US); Donald R. Battles, Arden Hills, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/760,963

(22) Filed: Jun. 11, 2007

(51) Int. Cl. B32B 3/10; B29C 35/08

(52) U.S. Cl. 428/131; 264/400

(57) ABSTRACT

There is provided a method of activating a substantially inelastic laminate to an elastic state by providing an elastic layer bonded on at least one face to a fibrous facing layer. The laminate is directed under laser beams so as to cut fibers of the at least one fibrous facing layer along perforation lanes in at least one region forming a laminate that is extensible and elastic in a direction generally transverse to the direction of the perforation lanes. This laminate is particularly adapted for use in personal care articles.

### TECHNICAL FIELD

The present invention relates to stretchable elastic film laminates comprising an extruded thermoplastic elastic film bonded on one or both sides to a nonwoven material and to methods and equipment for making such elastic nonwoven laminates and products such as disposable garments (including diapers, training pants, and adult incontinence briefs) in which they are used.

### BACKGROUND OF THE INVENTION

Elastic nonwoven laminates are highly desirable for use in the field of disposable absorbent articles such as diapers, adult incontinent products, feminine hygiene and the like. Elastic films by themselves are difficult to handle and have undesirable tactile and strength properties. For these reasons and others the art has proposed laminating nonwovens to elastic films and webs. The nonwovens strengthen the elastic material and provide a soft and non-tacky feel. The problem is that the attached nonwovens also tend to result in laminated products with little or no elastic properties as laminated. Numerous patents such as U.S. 2003/0087059, have addressed this problem. Many proposed solutions are directed at ways to “activate” the elastic nonwoven laminate, which generally involves weakening the nonwoven and/or the bond between the nonwoven and the elastic in the direction of desired elasticity, generally by stretching. Namely an elastic nonwoven laminate is formed and then placed under tension by a variety of techniques and stretched, see e.g., U.S. Pat. Nos. 5,156,793 or 7,039,990. The stretching weakens the attached nonwoven, and/or the bond between the nonwoven and the elastic, allowing the underlying elastic to more freely stretch and recover. One problem with this stretch activation approach is that it is difficult to obtain uniform stretching of the entire laminate at low elongations, which can be addressed by stretching the laminate to the natural draw ratio of the elastic film. However, if the laminate is stretched to the natural draw ratio of the elastic film to obtain uniform stretching of the laminate, the elastic properties may not be those desired and/or the laminate could break.

Another proposed method to obtain cross-direction elastic properties, discussed in U.S. Pat. No. 5,789,065, is by using nonwoven type fabrics that are necked prior to applying them to an elastic sheet. This is stretching of certain types of nonwoven fabrics or other fabrics that “neck” in when stretched, prior to lamination to an elastic film or the like. Necking is the process of reducing the width of a nonwoven or the like by stretching the nonwoven lengthwise. Not all nonwovens are neckable and those that are neckable neck in to different degrees and to different degrees of uniformity, so care needs to be made in selecting the nonwoven depending on the desired end product properties. The resulting necked nonwoven is subsequently relatively easily stretched in the width or cross direction at least up to its original width or cross direction dimensions. The necking process typically involves unwinding a sheet from a supply roll and passing it through a brake nip roll assembly driven at a given linear speed. A takeup roll, operating at a linear speed higher than the brake nip roll, draws the fabric and generates tension in the fabric needed to elongate and neck, as disclosed for example in U.S. Pat. Nos. 4,965,122 and 5,789,065. The 5,789,065 patent describes a problem with necking being uneven properties of the necked material with the edges of the nonwoven material necking to the greatest degree and the central area necking the least. This causes a difference in properties of the resulting elastic nonwoven laminate at the edges versus the center of the elastic laminate.

U.S. Pat. No. 5,804,021 discloses an alternative method of weakening a nonwoven by providing it with slits that extend in the machine or cross direction. Machine direction slits will allow an elastic nonwoven laminate cross direction elasticity and cross direction slits will allow an elastic nonwoven laminate machine direction elasticity, i.e. the elastic properties are perpendicular to the direction of the slits assuming the underlying elastic is elastic in either direction. This nonwoven weakened by slitting would make the nonwoven material difficult to handle if done prior to lamination and although post lamination slitting is mentioned there is no specific method disclosed as to how to successfully slit a nonwoven layer after lamination.

It has also been proposed to perforate an elastic nonwoven laminate as discussed in PCT Appln. No. WO 04/060666, and U.S. Appln. Nos. 2005/0158513 and 2004/0241389. In all of these documents it is warned that this process can greatly reduce the elastic recovery properties of the laminate and proposes specific methods to do this perforation that allegedly reduces this undesirable weakening. Both the perforating methods and the necking methods have limitations for making elastic laminates in terms of degree or direction of stretch and recovery, i.e., extension and retraction, of the laminate, uniformity of stretch and/or the economy of manufacture of the elastic laminates, thereby limiting the applications for such laminates.

There is a need for a practical method to weaken a nonwoven elastic film laminate by a method other than stretching, cutting the nonwoven prior to lamination or perforating the resulting laminate which will result in a laminate with predictable elastic recovery properties without weakening or compromising the underlying elastic film for the production of economical elastic laminates having desirable stretch and recovery abilities for applications such as personal care products.

### BRIEF DESCRIPTION OF THE INVENTION

The invention method activates a substantially inelastic or low level elastic laminate to an elastic state or more elastic state. An elastic layer is bonded on at least one face to a fibrous facing layer which makes the laminate substantially inelastic or less elastic than the elastic layer. This laminate is then directed under a series of laser beams so as to cut fibers of the at least one fibrous facing layer along perforation lanes in at least one region. The perforation lanes form a laminate that is extensible and elastic in a direction generally transverse to the direction of the perforation lanes.

### BRIEF DESCRIPTION OF THE DRAWINGS

The accompanying drawings are presented as an aid to explanation and understanding of various aspects of the present invention only and are not to be taken as limiting the present invention.

FIG. 1a is an end view of a laser slit elastic laminate as shown in FIG. 1b.

FIG. 1b is a top view of a laser slit elastic laminate with the elastic being provided as cross direction stripes.

FIG. 2 is a graph of elastic extension properties with respect to laser power for a laminate according to the invention as in Example 2.

FIG. 3a is an end view of the elastic laminate shown in FIG. 3b.

FIG. 3b is a top view of laser slit elastic laminate with discretely formed elastic patches.

FIG. 4 is a graph of stretch performance at various lane spacings per Example 3.

FIG. 5 is a graph of force versus extension for the material of Example 7.

FIG. 6 is an alternative activation lane pattern for Example 8.

FIG. 7 is a photomicrograph of an activation lane.

FIG. 8 is a photomicrograph of an activation lane.

FIG. 9 is a schematic drawing of the invention activation process according to one embodiment.

FIG. 10 is a top view of an elastic laminate having different patterned elastic according to the invention as in Example 1.

The present invention is directed to elastic laminates, typically including an elastic material layer such as a film, fibers or web, having first and second major surfaces with a thickness between these surfaces, and at least one nonwoven or fibrous facing layer bonded to at least one of the major surfaces of the elastic layer. “Bonding” as used herein includes all types of adhering including adhesives, thermal bonding, ultrasonic bonding, extrusion bonding, and the like, intended to permanently attach the two or more layers, at least in points or areas. Bonding however does not include extrusion bonding where the elastic significantly or substantially penetrates into at least one nonwoven or fibrous facing layer. The at least one nonwoven facing layer is scored or cut after lamination by focused laser beam radiation to partially or fully cut the fibers forming the nonwoven or fibrous facing layers without cutting through the underlying elastic material to activate the laminate and provide for desired predetermined elastic performance. Generally the nonwoven or fibrous facing layer materials include webs of thermoplastic filaments or fibers where the fibers can be single component and/or multi-component type fibers.

The term “multicomponent” or “bicomponent” refers to filaments or fibers which have been formed from at least two polymers extruded from at least two separate extruders but spun together to form one fiber and may also be referred to herein as “conjugate” fibers. “Bicomponent” is not meant to be limiting to only two constituent polymers. The polymers are arranged in substantially constantly positioned distinct zones across the cross-section of the bicomponent fibers and extend continuously along the length of the bicomponent fibers. The configuration of such a multicomponent or bicomponent fiber may be, for example, a sheath-core arrangement wherein one polymer is surrounded by another, or may be a side-by-side, A/B, arrangement or an A/B/A, side-by-side (-by-side), arrangement. For two component fibers, the polymers may be present in ratios of 75/25, 50/50, 25/75 or any other desired ratios. Conventional additives, such as pigments and surfactants, may be incorporated into one or both polymer streams, or applied to the filament surfaces.

As used herein, the terms “elastic”, “elastomeric”, and forms thereof, mean any material which, upon application of a biasing force, is stretchable, that is, elongatable or extendable, and which will return with force toward its original shape upon release of the stretching, elongating force. The elastic may include some permanent set which generally is less than 50 percent or 40 percent. The term may include precursor elastomerics that are heat activated or otherwise subsequently treated after application to a precursor structure to induce elasticity. The terms “extensible” and “extendable” interchangeably refer to a material which is stretchable in at least one direction but which does not necessarily have sufficient recovery to be considered elastic.

As used herein the term “elastic material” or “elastic film” will include such materials as films, fibers, scrims, foams, or other layers of elastic material.

“Layer” when used in the singular can have the dual meaning of a single element or a plurality of elements. A layer could for example be a multitude of extending filaments which could be parallel or intersecting or a series of discretely placed elastic elements. As used herein, the term “machine direction” or MD means the length of a fabric in the direction in which it is produced. The terms “cross direction” or “cross machine direction” or CD means the width of fabric, i.e. a direction generally perpendicular to the machine direction.

“Personal care product” or “personal care absorbent article” means diapers, wipes, training pants, absorbent underpants, adult incontinence products, feminine hygiene products, wound care items like bandages, and other like articles.

The term “polymer” generally includes without limitation homopolymers, copolymers (including, for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic and atactic symmetries.

“Nonwoven” refers to web or layer of material having a structure of individual fibers or filaments which are interlaid, but not in an identifiable manner as in a knitted fabric. Nonwoven fabrics or webs are formed from or by many processes such as, for example, extrusion processes, foam materials or processes, meltblowing processes, spunbond processes, air-laying processes, and bonded carded web processes. The basis weight of nonwoven fabrics is usually expressed in ounces of material per square yard (osy) or grams per square meter (grams per m²) and the fiber diameters are usually expressed in microns or denier. The fibers forming the nonwoven could be single layer or multicomponent fibers or filaments. The fibers or filaments could be formed of elastic and/or inelastic thermoplastic polymers or blends. The inelastic types of polymers are preferred as they are able to produce a laminate that is dimensionally stable prior to laser perforation and which still is dimensionally stable in at least one direction or extent after laser perforation.

“Activation” or “activate” or forms thereof refers to weakening of at least one nonwoven or fibrous facing layer in a direction that does not otherwise easily elongate by cutting or weakening the nonwoven or fibrous facing layer in a predetermined direction by the use of more than one laser activation lane also termed perforation lane. The perforation lanes extend in a given direction, which may be straight or curved, which direction is generally perpendicular to the direction of intended activation of the elastic laminate. Where nonwoven or fibrous facing layer are used on both faces of the elastic layer and only one nonwoven or fibrous facing layer is activated as described herein the opposing nonwoven or fibrous facing layer should be extensible in the direction of intended elasticity for the laminate. Generally it is not preferred to activate both sides of a laminate in the same direction using perforation lanes according to the invention as this increases substantially the likelihood of the laminate breaking when stretched. If one were to activate both sides of a laminate then the perforation lanes on the opposite faces of the laminate should be staggered. Overlapping lanes on opposing sides of the laminate would increase the likelihood of the elastic layer breaking.

The fibers or filaments forming the nonwoven or fibrous facing layer, or polymer otherwise forming the facing layer, can inherently absorb laser radiation or include additional laser-radiation absorbing compounds, in at least a layer of a fiber thereof or coated thereon, which compounds absorb incident laser light. When an absorbing dye is incorporated, its function is to absorb the incident radiation and convert this into heat, leading to more efficient heating at the spots that are radiated. It is preferred that the dye absorbs in the infrared region. Typical absorbing agents include clays, micas, TiO₂, carbonates, oxides, talc, silicates and aluminosilicates, and carbon black. Infrared absorbing agents include inorganic infrared absorbing agents and organic absorbing agents. Inorganic infrared absorbing agents can include, for example, tin oxide, indium oxide, magnesium oxide, titanium oxide, chromium oxide, zirconium oxide, nickel oxide, aluminum oxide, zinc oxide, iron oxide, antimony oxide, lead oxide, and bismuth oxide. Organic infrared absorbing agents can include, for example, phthalocyanines, naphthalocyanines, and anthraquinones. Examples of suitable NIR (near infrared absorbing) dyes which can be used alone or in combination include poly (substituted) phthalocyanine compounds and metal-containing phthalocyanine compounds; cyanine dyes; squarylium dyes; chalcogenopyryioacrylidene dyes; croconium dyes; metal thiolate dyes; bis(chalcogenopyrylo)polymethine dyes; oxyindolizine dyes; bis(aminoaryl)polymethine dyes; merocyanine dyes; and quinoid dyes. Infrared absorbing materials disclosed in U.S. Pat. Nos. 4,778,128; 4,942,141; 4,948,778; 4,950,639; 5,019,549; 4,948,776; 4,948,777 and 4,952,552, the substance of which are incorporated herein by reference in their entirety.

The term “perforate”, “perforation” or “perforated” and the like refers to laser cuts or holes in a nonwoven or fibrous facing layer used to create activation of the laminate. The laser perforations are generally 10 microns to 1000 microns in width, or 50 to 500 microns, and can extend from these width dimensions up to the full width or length of the laminate being laser perforated as described herein. The “length” dimension of the perforations is the direction of the perforation lanes which is the dimension that is generally perpendicular to the desired elastic properties of the laminate following activation. Perforations that run the full length or width of the laminate in a continuous manner produce webs that generally have consistent elastic properties at any given location on the web being treated. This could be a single continuous perforation or regular repeating patterns of individual perforations. Discontinuous regions of perforations in the lengthwise dimensions can be used to create discrete elastic regions. The individual laser perforations are generally at least 1 mm or 1 cm in length and can be points or extend as lane segments in straight lanes or in certain preferred embodiments as curved lanes, which individually or as a series or points or lane segments form the perforation lanes. The resulting laminate is weakened in a direction generally transverse to the length dimension of the perforation lanes allowing the underlying elastic material to extend and recover in this direction. For example, if the perforation lanes are all substantially parallel the resulting product will generally be elastic in a direction transverse to these parallel perforation lanes and generally inelastic or less elastic along the lengthwise extent of the parallel perforation lanes. If the perforations are discrete holes or the like the resulting laminate will be more extensible and resultantly elastic in the laminate direction transverse to the resulting perforation lanes created by the discrete perforations. Perforation lanes created by the discrete perforations could also be simply an array of discrete perforations not extending in any identifiable lane, where the lane direction is the direction where the perforations are more concentrated, such an array would generally be considered as forming multiple perforation lanes.

More complicated elastic properties can be obtained by using perforation lanes that extend in more than one direction, such as in a curve. A curved perforation lane can create an elastic laminate that extends in different directions at different points or regions of the laminate. An elastic material that will extend in different directions at different points is highly desirable in certain garment applications where the body part engaged flexes or moves in different directions at different points.

Elastomeric thermoplastic polymers useful in the practice of this invention as the elastic layer may be, but are not limited to, those made from block copolymers such as polyurethanes, copolyether esters, polyamide polyether block copolymers, ethylene vinyl acetates (EVA), vinyl arene (e.g. styrenic) containing block copolymers having the general formula A-B-A′ or A-B such as copoly(styrene/ethylene-butylene), polystyrene-poly(ethylene-propylene)polystyrene, polystyrene-poly(ethylene-butylene)-polystyrene, (polystyrene/poly(ethylene-butylene)/polystyrene, poly(styrene/ethylene-butylene/polystyrene), metallocene-catalyzed ethylene-(butene or hexene or octene) copolymers of a density of about 0.866-0.910 grams per cm³) and of highly stereo-regular molecular structure, and the like.

Useful elastomeric resins include, but are not limited to, block copolymers having the general formula A-B-A′ or A-B, where A and A′ are each a thermoplastic polymer endblock which contains a vinyl arene moity such as a poly (vinyl arene), which is typically styrene, and where B is an elastomeric polymer midblock such as a conjugated diene or a lower alkene polymer. Block copolymers of the A-B-A′ type can have different or the same thermoplastic block polymers for the A and A′ blocks, and the present block copolymers are intended to embrace linear, branched and radial block copolymers. In this regard, the radial block copolymers may be designated (A-B)m-X, wherein X is a polyfunctional atom or molecule and in which each (A-B)m-radiates from X in a way that A is an endblock. In the radial block copolymer, X may be an organic or inorganic polyfunctional atom or molecule and m is an integer having the same value as the functional group originally present in X. It is usually at least 3, and is frequently 4 or 5, but not limited thereto. Thus, in the present invention, the expression “block copolymer”, and particularly A-B-A′ and A-B block copolymer, is intended to embrace all block copolymers having such rubbery blocks and thermoplastic blocks as discussed above, which can be extruded and without limitation as to the number of blocks. A-B-A-B tetrablock copolymer are also considered block copolymers are discussed above may also be used in the practice of this invention as the elastic layer.

Elastomeric polymers also include copolymers of ethylene and at least one vinyl monomer such as, for example, vinyl acetates, unsaturated aliphatic monocarboxylic acids, and esters of such monocarboxylic acids. The elastomeric copolymers and formation of elastomeric nonwoven webs from those elastomeric copolymers are disclosed in, for example, U.S. Pat. No. 4,803,117.

The elastic material may also be a multilayer film material. Additionally, the elastic film may be a multilayer film material in which one or more of the layers is an inelastic film layer. An example of the latter type of elastic web, reference is made to U.S. Pat. Nos. 5,885,908; 5,344,691; 5,501,679 and 5,462,708, the substance of which are incorporated by reference in their entirety.

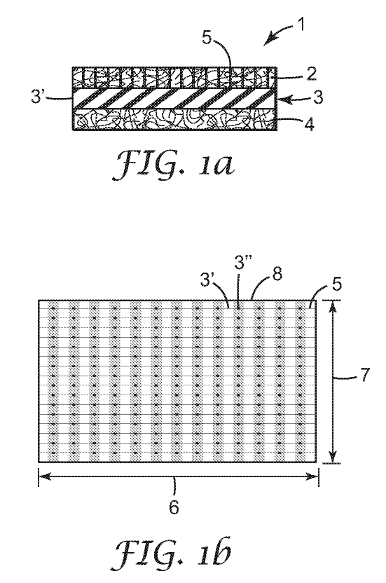

The elastic layer can also be discretely applied as regular geometric shapes, such as lines or trapezoids, or irregular shapes formed by a roll transfer process as is described in U.S. Patent Publication. No. 2003/0087059, the substance of which is incorporated by reference in its entirety. This patent document describes transferring thermoplastic elastomeric material to the outer surface of a roll in a discrete form and then transferring the at least still partially molten thermoplastic elastomeric as discrete shapes to a web, generally a nonwoven web. The thermoplastic elastomeric composition preferably at least partially penetrates the nonwoven web material, but penetrating only so much as to assure that it is adhered. The elastomeric composition should not fully penetrate into the nonwoven, which would reduce the elasticity of the elastomer and prevent activation by weakening the nonwoven web by the invention method. Alternatively, the nonwoven web could be precoated with an adhesive such that the thermoplastic elastomeric polymer on the roll is at least in part adhesively transferred to the nonwoven, which would require little or no encapsulation of fibers of the nonwoven by the thermoplastic elastomeric composition. This lamination process allows the creation of an elastic layer that has differing thicknesses of elastic in different areas of the laminate. This type of elastic layer with discrete elastic shapes and thicknesses can be used to create breathability if the elastic is otherwise a continuous film. Specifically the laser power and/or focus could be adjusted to both weaken the nonwoven web and the elastic in thin areas of the elastic layer without affecting the elastic performance in thicker elastic regions or areas. When the laminate is then stretched, the elastic can break in these thin weakened areas and create breathability while maintaining the laminate integrity and elastic performance via the thicker elastic regions. An example of this is shown in FIGS. 1a and 1b, where the elastic layer 3 is a series of thick transverse (width dimension extending) lanes or strands 3′ with intervening thinner lanes of elastic 3″. The laser perforation lanes 5 cut the upper nonwoven layer 2 running in the longitudinal direction 6. Where the laser perforation lanes 5 intersect the thinner lanes of elastic 3″ they create points or regions 8 that easily break when the elastic laminate is subsequently stretched in the transverse direction 7. This creates a netlike elastic laminate that has integrity in the longitudinal direction due to the still intact elastic layer 3 and the attached nonwoven layer 4 without requiring that longitudinal strands of elastic be provided with predetermined perforations between the longitudinal and transverse elastic strands.

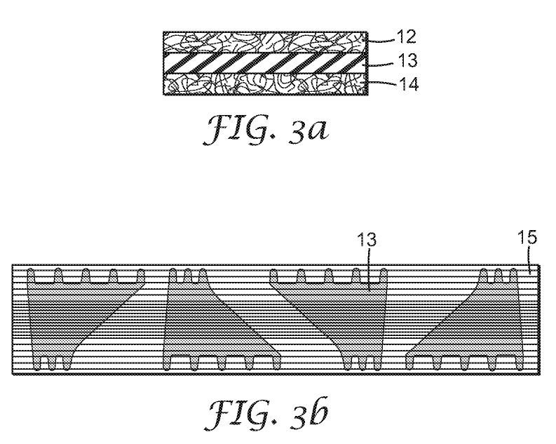

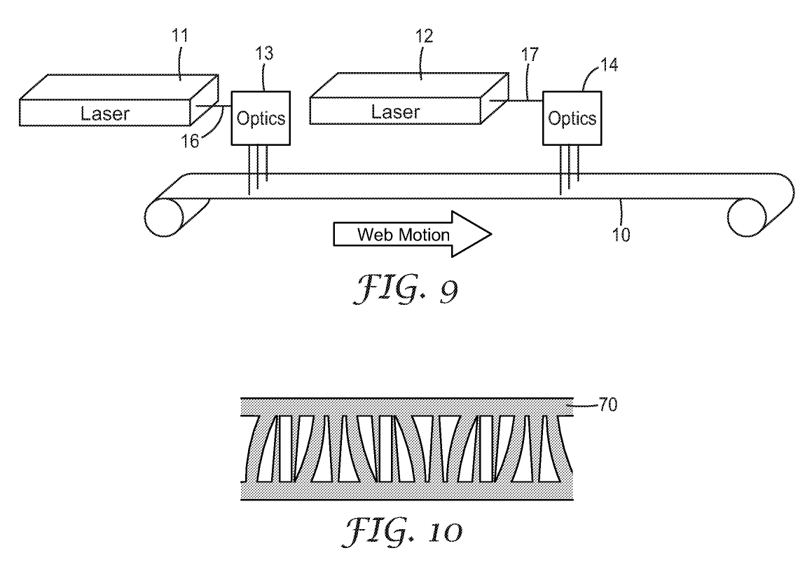

At a laser treatment assembly, as shown in FIG. 9, an outer nonwoven layer on one face of a laminate 10 is perforated, preferably along straight or curved perforation lanes extending in at least one direction, continuously or discontinuously. With discontinuous perforation lanes the outer nonwoven facing layer could be perforated by a series of discrete spots that also extend in a given direction as straight or curved perforation lanes. By spots it is meant perforations that could be any shape from a circular shape to a lane segment extending in a straight or curved fashion. The laser perforation lanes are generally spaced apart such that the elastic laminate can subsequently be easily extended to exhibit elastic properties but not break. If the laser perforation lanes are spaced too closely the laminate will tend to break when stretched due to weakening of the elastic layer. If the laser perforation lanes are spaced too far apart the laminate will also tend to break due to concentration of the stress in too few locations when the laminate is subsequently stretched. The multiple spaced laser perforation lanes or lines can vary in spacing but generally are on average spaced 1 to 5 mm or 2 to 4 mm. The subsequent extension of the laser treated product could be performed by hand or mechanical methods, which mechanical methods could include known methods of activation discussed in the background section. If known activation methods are used they would not need to weaken the nonwoven layer as this would already have been done by the laser treatment, so a much more uniform and predictable elastic product could be obtained. With laminates of the invention the elastic layer is generally 50 to 500 microns thick, in the thickest portion if of variable thickness, or 100 to 200 microns thick. The nonwoven basis weight is generally 15 to 100 grams per m² on the face being treated by laser, or generally 20 to 50 grams per m². On the opposite face the nonwoven, if provided, is generally a lower basis weight nonwoven so that it is extensible without the need for activation, generally 10 to 50 grams per m² or 15 to 40 grams per m². The elastic layer in the thickest areas provides for structural integrity while thinner elastic regions could be provided to allow for the creation of perforations, as described above. The nonwoven or fibrous layer in which the perforation lanes are created should be thick enough to allow for a substantially continuous cutting without creating burn spots in the underlying elastic layer. For example a net-like nonwoven would allow the lasers to burn into the underlying elastic layer. However if the nonwoven layer is too thick, it would be more difficult to uniformly cut into the nonwoven layer to a predetermined depth at high production rates. In the area desired to be elastically activated there are preferably at least two laser perforation lanes and preferably at least 10 lanes per 30 mm of width. If the laser perforation lanes are provided as a line of closely spaced spots these discrete spots are generally spaced less than 1000 microns or less than 500 microns. The lanes 15 could have variable spacing to create differential properties, such as shown in FIG. 3b.

Referring to FIG. 9 the lasers 11 and 12 could be used singly or in combination, or with further lasers as desired. The beams of light 16 and 17 can be directed by mirror assemblies 13 and 14, respectively, to create desired lane configurations and designs on the outer nonwoven or fibrous layer of the laminate 10. The beams of light 16 and 17 can also be divided into multiple beams of light by beam splitters and then directed by mirror assemblies 13 and 14 if desired.

In a preferred embodiment the laser beam can be focused to create curved perforation lanes in one or multiple patterns by the use of one or more mirrors. The laser as such could provide a laminate that has a wide range of different zones having different extents and directions of elastic extensibility. This could be done by one pass over multiple focused lasers or stepwise treatment with multiple laser treatment steps as shown schematically in FIG. 9. One use of this would be to create a garment, such as a diaper, that allows elastic extension in one direction at the waist area and a different direction of elastic extension at the leg area or even an elastic zone that continuously varies in both direction of elastic extensibility and degree of elastic extensibility. This is an extremely powerful tool to create elasticity where and how it is needed by post process manipulation of one predetermined laminate. The same predetermined laminate could be used to form an infinite variety of activated elastic products.

As previously discussed, lasers are the energy source for perforating the nonwoven facing layer without ablating or significantly affecting the underlying elastic material. With the preferred nonwoven layer the fibers are cut such that on either side of the laser perforation lane there are discrete fiber ends having retracted melt regions adjacent the sides of the perforation lane. Fiber regions adjacent (e.g. 200 or 100 microns) these retracted melt regions are substantially unchanged by the laser heat treatment (i.e. having orientation or crystallinity substantially identical to regions of the fiber distant from the laser perforation lane side edges (e.g. 200 microns or more)). The laser in a preferred embodiment also can fuse at least some of the fibers adjacent the elastic material layer in the perforation lane into the elastic material creating a more secure bonding of the nonwoven to the elastic layer. The laser energy should be sufficient to melt or ablate at least some of the fibers in the laser perforation lane so as to substantially weaken the nonwoven web in the perforation lane but generally not weaken the underlying elastic layer to any significant extent, unless this is desired in certain predetermined areas as discussed above. This is accomplished by adjusting the laminate speed, the basis weight of the nonwoven, and the laser width and the average peak energy of the laser among other factors.

All “lasers” (i.e., standing for light amplification by stimulated emission of radiation) are sources of light, and specifically are forms of electromagnetic radiation which propagates at a velocity of 3×10¹⁰ centimeters per second, and are characterized by oscillating electric fields. Particularly, lasers have many advantages. First, the laser light can be generated to propagate with a consistent distribution of energy, or profile, for a distance allowing it to be delivered to processing locations. The path of this energy can be directed or steered along the desired path. Further, the amount of energy per unit time, or power delivered in the profile can also be controlled. Even further, the laser light profile can be concentrated and focused to expose the desired area at the processing location. While many laser types may be suitable for the perforation or cutting of the nonwoven layer(s) as described herein, infrared light lasers are preferred. A preferred infrared laser is a CO₂ laser. A CO₂ laser can either provide continuous or pulsed laser emissions. This laser type has had industrial uses in welding, drilling, heating and heat treating. A CO₂ laser is a molecular laser that operates on molecular energy levels and uses a mixture of carbon dioxide and nitrogen. Operation of a carbon dioxide (CO₂) laser involves the excitation of vibrational levels of the nitrogen molecules by collisions with electrons in the electrical discharge, followed by energy transfer to an excited vibrational level of the carbon dioxide molecule, and followed by radioactive decay from that excited state.

The CO₂ laser, particularly at a wavelength of 10.6 microns, is extremely useful for perforating the preferred nonwoven fibrous facing layer of the invention laminate because a CO₂ laser beam can be focused and vaporize or melt at least the uppermost fibers of the fibrous layer. The polymer forming the fibers absorbs the laser energy and converts it into heat thereby causing the fibers to be ablated, disrupted or cut. The depth and amount of the laser perforation as mentioned above is primarily related to laser power, laser focusing, and translation speed. The translation speed is the speed with which the laminate surface exposed to laser energy travels relative to the laser beam. The laser power and focusing should be adjusted to the translation speed and the fibrous facing layer thickness and energy absorption characteristics of the fibrous facing layer so that the laser does not ablate or significantly affect the underlying elastic material. The laser exposure need not sever or weaken all the fibers in the perforation regions as long as sufficient fibers are cut or weakened so as to allow extension of the elastic material under normal tensions without breakage or tearing of the laminate. The CO₂ laser beam as such is focused on the fibrous facing layer as to only cut or weaken the fibers of the fibrous facing layer to a certain prescribed depth.

The laser can use a stationary beam in either continuous or intermittent operation to make cuts in the fibrous facing layer. Alternatively, one could use a guided laser beam (continuous or intermittent) to provide any combination or number of patterns. Multiple beams can also be used.

Material properties and laser wavelengths can be adjusted to enhance the absorption of the laser energy to encourage perforating or cutting, or adjusted to lessen the absorption of laser energy to make the material “transparent” to the laser energy. In a multi-layered structure it is feasible to have the laser pass through an upper layer of material without affecting it and then cut (or modify) a material below the first material.

An alternative type of laser that can be used herein is a visible light laser. An argon ion laser represents laser technology in the visible portion of the light spectrum offering the capability of continuous or intermittent power output.

An alternative type of laser that can be used herein is an ultraviolet light laser. Excimer lasers represent laser technology in the ultraviolet portion of the light spectrum offering the capability of pulsed short-wavelength lasers having high peak power. A leading example of excimer lasers is the krypton fluoride laser.

Yet another type of laser is a solid state laser or dye type lasers. These lasers represent laser technology which can span the infrared portion to the ultraviolet portion of the light spectrum, and also offer high peak power and high continuous power. One example of this type of laser is the Nd: YVO₄ or neodymium-doped yttrium vanadate infrared laser, and its shorter wavelength harmonics.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

### Example 1

An elastic nonwoven laminate was prepared according to the methods outlined in copending U.S. application Ser. No. 11/531,825 (incorporated by reference herein in its entirety). The laminate was comprised of a core elastic layer 13, as shown in FIG. 3a, consisting of a blend of 70% by weight styrene-ethylenebutylene-styrene block copolymer (KRATON G1657) and 30% by weight metallocene-catalyzed polyethylene (ENGAGE 8452) and 2 parts per hundred (pph) TiO2 MB, sandwiched between outer layers of nonwoven web 12 and 14 (Product 3320, available from BBA Nonwovens). The nonwoven was a high extension carded nonwoven with a basis weight of 27 grams per square meter. The core elastic layer 13 was present as a patterned design 70, as shown in FIG. 10, with an average thickness of about 200 microns in the thick areas. The face of each nonwoven layer to be bonded to the patterned elastic web was spray-coated with an adhesive (Bostick HX9453-01-PAO) applied at approximately 4.5 grams per square meter coating weight. In the production of the trilayer laminate, the elastic core layer was contacted with (by extrusion onto) a first layer of the adhesive coated nonwoven (hereafter referred to as the extrusion laminated side, ELS). The opposing side of the elastic layer was then contacted with (by lamination in a nip) a second layer of adhesive coated nonwoven (hereafter referred to as the adhesive laminated side or ALS). In this context, the “downweb” or “machine” direction thus refers to the direction along the long axis of a nonwoven/elastic laminate formed via the above-described process. “Crossweb” refers to the direction across the width of a laminate made via the above process.

The laminate was treated with a laser as follows. A CO₂ laser was provided (available from Synrad, Model Evolution 100). The laser was operated under the following operating conditions: wavelength—10.6 microns, mode quasi-continuous wave, scan rate—1000 mm per sec. The emitted laser beam (4.0 mm diameter) was reduced by means of a combination of collimating and focusing optics to a final beam diameter of 100 microns. The laminate was held stationary on a flat horizontal table and the laser beam was traversed across the laminate in the desired pattern by means of an XY plotter.

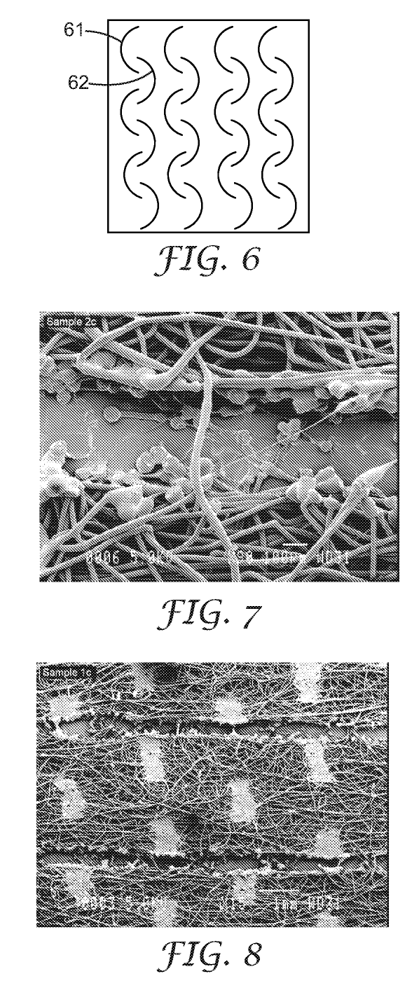

A laminate sample of size approximately 300 mm×300 mm was exposed to the laser beam in a series of parallel lanes that traversed the laminate at a lane spacing of 3 mm, in the downweb direction of the laminate. Some laminate samples were treated on the extrusion laminated side (ELS); other samples were treated on the adhesive laminated side (ALS). The laser power was adjusted between 0 and 62 Watts. The laser treatment resulted in a laminate having machine direction perforation lanes, having melted terminal ends of non-woven fibers on either side of the perforation lanes as can be observed in FIGS. 7 and 8. The melted terminal ends are in the shape of nodules. In this example, the center-to-center lane spacings were targeted at 3 mm. Test samples were cut from the laminate. The lane spacing shown in FIG. 3b is a possible alternative but the perforation lanes were actually equally spaced.

Physical properties of the laminate samples were tested through two elongation cycles in an Instron 5500R Model 1122 tensile testing machine. The first cycle is termed first hysteresis and the second cycle is termed second hysteresis. A 50 mm wide by 60 mm long piece of laminate was mounted in the machine with the upper and lower jaws 25 mm apart. The jaws were then separated at a rate of 51 cm per minute until a load of about 15 Newtons was reached, or the sample broke or delaminated. The jaws were then held stationary for one second after which they returned to the zero elongation position. The jaws were again held stationary for one second and then separated at the same rate until a load of about 15 Newtons was reached, or the sample broke or delaminated.

Samples were tested that had not been laser treated (control samples), that had been laser treated only on the ELS, and that had been laser treated only on the ALS. All elongations were performed in the crossweb direction of the sample; that is, in the direction orthogonal or transverse to the perforation lanes imparted by the laser treatment.

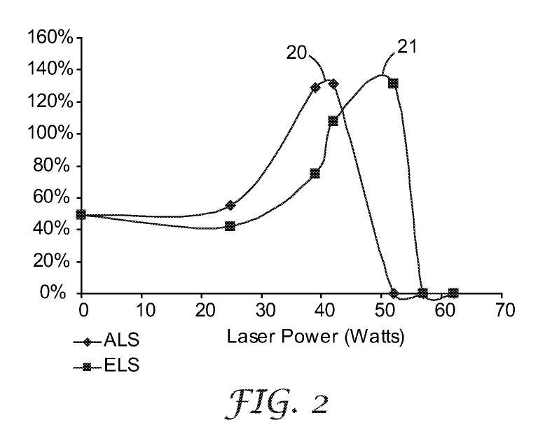

Table 1 demonstrates the variation of laser power and the effect on second hysteresis stretch performance (percent extension at 15 Newtons, zero percent means the material broke). In Table 1 ALS or ELS refers to the side having laser treatment. FIG. 2 illustrates the Table 1 data of the second hysteresis stretch versus laser power on ALS 20 and ELS 21. As laser power increased elastic stretch performance increased then dropped as the laser resulted in breakage.

TABLE 1

| | Laser Power | Second | Second |
|---|---|---|---|
| Example | (Watts) | Hysteresis ALS | Hysteresis ELS |
| control | 0 | 49% | 49% |
| Ex1-2 | 24.8 | 55% | 42% |
| Ex1-3 | 38.9 | 129% | 75% |
| Ex1-4 | 42 | 131% | 108% |
| Ex1-5 | 52 | 0% | 131% |
| Ex1-6 | 57 | 0% | 0% |
| Ex1-7 | 62 | 0% | 0% |

### Example 2

A laminate was made using the same conditions as Example 1 with the exception of the patterned roll forming the elastic layer 13, which is shown in FIG. 3b. The laminate was cut by equally spaced laser perforation lanes 15 as in Example 1. Table 2 demonstrates the variation of laser power (watts) and the effect on second hysteresis stretch performance (percent extension at 15 Newtons, zero percent means the material broke).

TABLE 2

| | Laser | Second | Second |
|---|---|---|---|
| Example | Power | Hysteresis, ALS | Hysteresis, ELS |
| 2-1 | 0 | 44% | 44% |
| 2-2 | 52 | 82% | 91% |

### Example 3

The laminate was prepared as in Example 1 except that:
a) the adhesive was Cavidad 34-862b, available from National Starch
b) the adhesive coating weight was 4.5 grams per m²
c) the elastic was extruded in a continuous film form
d) elastic thickness was about 125 microns

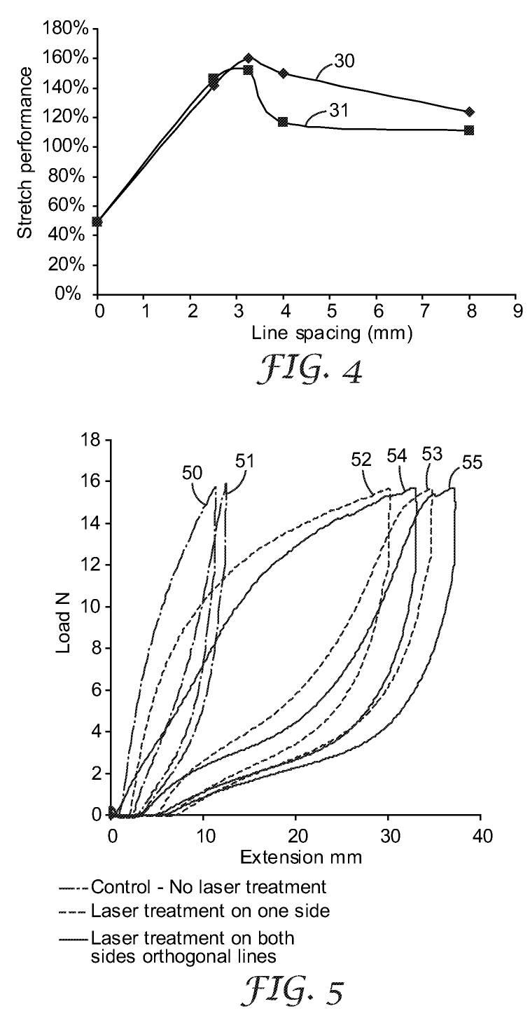

The laminate was treated with a laser as in Example 1. The center-to-center lane spacing was varied to determine the effect of lane spacing on laminate performance. The laser power was maintained at 33.3 Watts. The results are shown in Table 3 and graphically in FIG. 4, with the ALS curve 30 and ELS curve 31.

TABLE 3

| | Lane | Second | Second |
|---|---|---|---|
| Example | spacing | hysteresis ALS | hysteresis ELS |
| 3-1 | 0 | 49% | 49% |
| 3-2 | 2.5 | 142% | 146% |
| 3-3 | 3.25 | 160% | 152% |
| 3-4 | 4 | 150% | 117% |
| 3-5 | 8 | 124% | 111% |

### Example 4

An elastic laminate was prepared in the same manner as that of Example 2.

The laminate was treated with a laser as follows. A pulsed CO₂ laser (Coherent Model Diamond 84) was provided. The laser was operated under the following operating conditions: repetition rate—1 kHz, pulse width—37 microseconds, average power—15.7 W, single pulse energy—15.7 mJ. The emitted laser beam (7.0 mm diameter) was reduced by means of focusing optics and field correction optics to a final beam diameter of 0.25 mm. The laminate was held stationary on a flat horizontal table and the laser beam was traversed across the laminate in the desired pattern by means of a General Scanning System, using focusing module E10-095071, and galvanometer-based optical scanning mirrors 656188, driven by a Nutfield SPICE card using Scanware Editor 3.1.

Laminate samples of 300 mm×300 mm were exposed to the laser beam (“scanned”) in a series of parallel perforation lanes that traversed the laminate, in the downweb direction. All samples were treated on the ELS. The samples were treated at various scan rates and lane spacings as shown in Table 4 and 5. The data in Table 4 is for examples wherein the perforation lanes were cut at a scan rate of 250 mm per sec and for Table 5 at a scan rate of 150 mm per sec. Physical properties were then tested in the same manner as in Example 2 except that the samples were 40 mm in width. Extensions were in the crossweb direction of the samples (orthogonal to the scanned laser lanes). The data in Table 4 and 5 shows the percent extension at 15 Newtons force.

TABLE 4

| | Lane | |
|---|---|---|
| | spacing | Second |
| Example | (mm) | hysteresis |
| 4-1 | 0 | 43% |
| 4-2 | 2.5 | 140% |
| 4-3 | 5.37 | 120% |
| 4-4 | 6.67 | 170% |
| 4-5 | 10 | 88% |
| 4-6 | 18.22 | 94% |

TABLE 5

| | Lane | |
|---|---|---|
| | spacing | Second |
| Example | (mm) | hysteresis |
| 4-7 | 0 | broke |
| 4-8 | 2.5 | broke |
| 4-9 | 5.37 | broke |
| 4-10 | 6.67 | broke |
| 4-11 | 10 | broke |
| 4-12 | 18.22 | broke |

### Example 5

A laminate was made using the same conditions as example 1 with the exception of the patterned roll and adhesive type, National Starch adhesive 34-862B. The resultant laminate is similar to that shown in FIG. 1b. The test specimen was cut from the laminate as shown in FIG. 1a. The laminate was treated with a laser as in Example 1 with laser power being varied between 0-62 Watts at 2.5 mm center-to-center lane spacing. Physical properties are shown in Table 6, which show the effect of laser treatment on an elastic laminate extruded in a mesh pattern and treated with a quasi continuous laser, and with a lane spacing of 3 mm, a lane width of 150 um and a scan rate of 1000 mm per sec. Laser treatment of this pattern resulted in open spaces in the mesh after the laminate had been stretched thus providing breathability without compromising the elastic properties.

TABLE 6

| | Laser power | Second | Second |
|---|---|---|---|
| Example | (Watts) | hysteresis ALS | hysteresis ELS |
| 5-1 | 0 | 49% | 49% |
| 5-2 | 62 | 80% | 123% |

### Example 6

A laminate was made using a Pillowbond™ spunbond polypropylene nonwoven (First Quality Nonwovens, Hazelton, Pa., 34 grams per m²) that was pulled under tension into the grooves of a corrugation roll and into a nip with a rubber roll as the other nip roll. A high extensibility carded web (BBA Non-wovens, Charotte, N.C., 27 grams per m²) was fed into the nip under low tension from the other direction, and the two webs were extrusion bonded to an elastic film at the nip. The elastic film consisted of a blend of Kraton™ G1657 (70%, 29 grams per m²) and Huntsman L8101 LLDPE (30%, 12 grams per m²). Since one side of the nip was a corrugation roll, only the high points of the Pillowbond™ web were extrusion bonded to the film. The laminate was then laser treated (samples were treated on one side or the other) and tested as in Example 3 and was elastic when treated on either side. This example shows that laser activation works with extrusion bonded materials and with various types of non-woven materials.

Laminate samples of 40 mm×40 mm were exposed to the laser beam (“scanned”) in a series of parallel lanes that traversed the laminate. For these samples (that had been stretched in the crossweb direction), the laser was scanned in the downweb direction. Physical properties were then tested in the same manner as in Example 3. Elongations were in the crossweb direction of the samples (orthogonal to the scanned laser lanes). The resulting stress versus strain (load versus extension) curves for a typical set of samples 52, 53 and 54, 55 are shown in FIG. 5, versus that of control samples 50 , 51 that were not laser treated.

An additional sample was prepared by laser treating, both sides of the laminate with two sets of perpendicular lanes (the treatment on one face was perpendicular to the treatment on the opposite face). The resulting stress strain curves are shown as 54 and 55 in FIG. 5. For each sample the first elongation is the leftmost cycle and the second elongation is the rightmost cycle.

### Example 7

An elastic laminate was made as in Example 3 and laser treated as in Example 3 at 33.3 Watts with a lane spacing of 3 mm.

Physical properties were then tested in the same manner as in Example 3. The stress versus strain 2-cycle hysteresis curve for the non-laser treated sample is shown as 50, 51 in FIG. 5.

Laminate samples of 50 mm×60 mm were exposed to the laser beam (“scanned”) in a series of parallel lanes that traversed the laminate on the ELS. The resulting stress versus strain curve is 52, 53 in FIG. 5.

An additional sample was prepared by laser treating both sides of the laminate with two sets of perpendicular lanes (the treatment on one face was perpendicular to the treatment on the opposite face). The resultant stress strain curves are shown as 54 and 55 in FIG. 5.

For each sample the first elongation is the leftmost cycle and the second elongation is the rightmost cycle.

### Example 8

An elastic laminate was prepared in similar manner to that of Example 2. In this case the elastic material (of the same composition of that of Example 2) was extruded onto a patterned forming roll such that the elastic material was present in a pattern, with areas of relatively thick elastic, and with relatively thin elastic in the remaining areas. A laminate was then formed in a similar manner to Example 2, using the same nonwoven and spray adhesive as that in Example 2.

The laser system used was as in Example 4, except the pulse width was 37 microseconds. A scan rate of 235 mm per sec and 1000 mm per sec was used. The pattern of the lanes cut was similar to that illustrated in FIG. 6. The example was elastic when stretched. The scan speed was varied from 230-1000 mm per sec.

What is claimed is:

1. A method of activating a substantially inelastic or low level elastic laminate to an elastic state or more elastic state comprising:
providing an elastic layer bonded on at least one face to a fibrous facing layer,
directing the laminate under laser beams so as to cut fibers of the at least one fibrous facing layer along perforation lanes in at least one region forming a laminate that is extensible and elastic in a direction generally transverse to the direction of the perforation lanes.

2. The method of claim 1 wherein the elastic layer is a film layer and the fibrous layer is a substantially inelastic nonwoven layer and the activation uses a series of closely spaced perforation lanes that are spaced on average 1 to 5 mm.

3. The method of claim 2 wherein the elastic film layer has discrete shaped elastic regions created by thick elastic regions interconnected by thin elastic regions.

4. The method of claim 3 wherein the elastic film layer in the thin regions is weakened such that the laminate breaks in the thin elastic regions when elongated transverse to the direction of the closely spaced perforation lanes creating a breathable laminate.

5. The method of claim 2 wherein the closely spaced perforation lanes are separated by from 2 to 4 mm on average.

6. The method of claim 2 wherein there are at least 10 closely spaced perforation lanes per 30 mm width in an activation region of the laminate.

7. The method of claim 1 wherein the elastic layer has a thickness of 50 to 500 microns and the fibrous layer, having the perforation lanes, is from 15 to 100 grams per meter².

8. The method of claim 1 wherein the elastic layer has a thickness of 100 to 200 microns and the fibrous layer, having the perforation lanes, is from 20 to 50 grams per meter².

9. The method of claim 1 wherein the elastic layer has a thickness of 50 to 500 microns and an opposing fibrous layer, not having the perforation lanes, is from 10 to 50 grams per meter².

10. The method of claim 1 wherein the elastic layer has a thickness of 100 to 200 microns and an opposing fibrous layer, not having the perforation lanes, is from 15 to 40 grams per meter².

11. The method of claim 1 wherein the laminate is subsequently extended in a direction generally transverse to the direction of the perforation lanes.

12. The method of claim 11 wherein the laminate is subsequently extended mechanically.

13. An activated elastic laminate comprising an elastic layer bonded on at least one face to a fibrous facing layer having discrete perforation lanes in at least one region forming a laminate that is extensible and elastic in a direction transverse to the direction of the perforation lanes, where at least some of the fibers in the perforation lanes have been ablated.

14. The activated elastic laminate of claim 13 where fibers adjacent sides of the perforation lanes have retracted melt regions and fiber regions adjacent these retracted melt regions have orientation or crystallinity substantially identical to regions of the fiber distant from retracted melt regions.

15. The activated elastic laminate of claim 13 wherein the elastic layer is a film layer and the fibrous layer is a nonwoven layer and the activation uses a series of closely spaced perforation lanes that are spaced on average 1 to 5 mm.

16. The activated elastic laminate of claim 13 wherein the elastic film layer has discrete shaped elastic regions created by thick elastic regions interconnected by thin elastic regions.

17. The activated elastic laminate of claim 16 wherein the elastic film layer in the thin regions is weakened such that the laminate breaks in the thin elastic regions when elongated transverse to the direction of the closely spaced perforation lanes creating a breathable laminate.

18. The activated elastic laminate of claim 15 wherein the closely spaced perforation lanes are separated by from 2 to 4 mm on average.

19. The activated elastic laminate of claim 15 wherein the elastic layer has a thickness of 50 to 500 microns and the fibrous layer, having the perforation lanes, is from 15 to 100 grams per meter².

20. The activated elastic laminate of claim 15 wherein the elastic layer has a thickness of 100 to 200 microns and the fibrous layer, having the perforation lanes, is from 20 to 50 grams per meter².

21. The activated elastic laminate of claim 15 wherein the elastic layer has a thickness of 50 to 500 microns and an opposing fibrous layer, not having the perforation lanes, is from 10 to 50 grams per meter².

22. The activated elastic laminate of claim 15 wherein the elastic layer has a thickness of 100 to 200 microns and an opposing fibrous layer, not having the perforation lanes, is from 15 to 40 grams per meter².

23. The activated elastic laminate of claim 15 wherein the perforation lanes are continuous.

24. The activated elastic laminate of claim 15 wherein the perforation lanes are a series of closely spaced discrete perforations.

25. The activated elastic laminate of claim 15 wherein the perforation lanes are curved at least in part.

26. The activated elastic laminate of claim 15 wherein there are multiple activation regions formed with discrete perforation lanes.

27. A personal care garment formed using an activated elastic laminate comprising an elastic layer bonded on at least one face to a fibrous facing layer having discrete perforation lanes in at least one region forming a laminate that is extensible and elastic in a direction transverse to the direction of the perforation lanes, where at least some of the fibers in the perforation lanes have been ablated.

28. The personal care garment of claim 27 wherein there are multiple activation regions formed with discrete perforation lanes.

29. The personal care garment of claim 27 wherein at least some of the perforation lanes are curved at least in part forming body conforming elastic regions.
